(19) United States
(12) Patent Application Publication
(10) Pub. No.: US 2019/0366525 A1
(43) Pub. Date: Dec. 5, 2019

(54) FLYWHEEL-DRIVEN SETTING DEVICE

(71) Applicant: HILTI AKTIENGESELLSCHAFT, Schaan (LI)

(72) Inventors: Dominik SCHMIDT, Feldkirch (AT); Tilo DITTRICH, Feldkirch (AT); Raphael THON, Wiener Neustradt (AT)

(21) Appl. No.: 16/461,577

(22) PCT Filed: Nov. 13, 2017
(86) PCT No.: PCT/EP2017/079066

§ 371 Date: Jun. 7, 2019

(30) Foreign Application Priority Data
Nov. 18, 2016 (EP) 16199460.3

(51) Int. Cl. B25C 1/06

(52) U.S. Cl. CPC B25C 1/06

(57) ABSTRACT

A flywheel-driven setting device for driving fastening elements into a subsurface comprises at least one flywheel which is directly driven by an electric motor. The flywheel comprises two internal rotor motors.

### FIELD OF INVENTION

The invention relates to a flywheel-driven setting device for driving fastening elements into a subsurface, with at least one flywheel directly driven by an electric motor.

### PRIOR ART

An electrically operated drive-in device for fastening elements is known from the German disclosure document DE 10 2005 000 077 A1, having a drive arrangement for a drive-in plunger which is mounted displaceably in a guide and has at least one drive flywheel which can be set in rotation over an electric motor, and having a return means over which the drive-in plunger is transferable into an initial position. A fastener driving tool is known from European patent specification EP 2 127 819 B1 adapted for driving fasteners into a workpiece comprising at least one electric motor having a central stator and an outer rotor adapted to rotate about the stator, wherein at least a part of the rotor comprises the flywheel.

### PRESENTATION OF THE INVENTION

The object of the invention is to provide a flywheel-driven setting device for driving of fastening elements into a subsurface, with at least one flywheel directly driven by an electric motor, which has high efficiency and long service life.

The object of a flywheel-driven setting device for driving fastening elements into a subsurface, with at least one flywheel directly driven by an electric motor, is achieved by the flywheel drive comprising two internal rotor motors. The fastening elements are, for example, nails or bolts which are driven into the subsurface using a setting device, also known as a setting tool. The setting energy is advantageously provided by the electric motor and transmitted via the flywheel to a driving element, also known as the setting piston. For this purpose, the flywheel is set in rotation by the electric motor. The rotational energy of the flywheel is transmitted to the driving element for a setting process, in particular, the setting piston, which is also abbreviated to piston. Using the driving element, especially the piston, the fastening element is driven into the subsurface. For this purpose, the flywheel is set in rotation by the electric motor. The rotational energy of the flywheel is transmitted to the driving element for a setting operation, in particular, the setting piston, which is also abbreviated to piston. With the help of the driving element, especially the piston, the fastening element is driven into the subsurface. For transmitting the rotational energy from the flywheel to the driving element, the flywheel is frictionally connected to the driving element, for example using a suitable coupling means. For this purpose, the driving element can be arranged between the flywheel and a counter roller. After a setting operation, the driving element is detached from the flywheel by opening the coupling means. The driving element can be reset to its initial position by a suitable return means, e.g. a spring means. Due to the design of the flywheel drive with two internal rotor motors, advantageously high torques can be quickly provided for the flywheel. The relatively small flywheel drive can easily be integrated into a hand-held setting device. The direct drive of the flywheel by the internal rotor motors has the advantage that undesirable efficiency losses are avoided.

A preferred exemplary embodiment of the flywheel-driven setting device is characterized in that the flywheel drive comprises two inner rotors each rotatably arranged in a stator means. The two internal rotors of the preferably brushless internal rotor motors are arranged together with the stator means advantageously symmetrically in relation to the flywheel. Due to the flywheel drive via two motor units, which share the inner rotor, the flywheel drive maintains a high performance with a low total weight. Coils or coil windings of the preferably brushless internal rotor motors can be advantageously radially arranged very far outside. This has the advantage that heat generated in the coils or coil windings during operation can be conducted directly to the environment. This reliably prevents heat build-up inside the internal rotor motors. Internal mechanically sensitive electromagnets of the internal rotor motors are advantageously protected against undesirable high centrifugal accelerations or strong vibrations.

Another preferred exemplary embodiment of the flywheel-driven setting device is characterized in that the two inner rotors are non-rotatably connected to a rotor shaft which extends through the stator means. The rotor shaft is rotatably mounted in the axial direction preferably outside the inner rotors and the stator devices, for example in a fixed supporting structure of the setting device using suitable bearing means.

Another preferred exemplary embodiment of the flywheel-driven setting device is characterized in that the inner rotors comprise permanent magnets that are radially rotatable within the stator means and that cooperate with stator windings. The permanent magnets on the rotor shaft cooperate over the stator means, in particular over the coils or coil windings of the stator means.

Another preferred exemplary embodiment of the flywheel-driven setting device is characterized in that the inner rotors comprise rotor windings rotatable radially within permanent magnets of the stator means. This enables a simple design of the electric motor as a DC motor with permanent magnets. The inner rotors can consist entirely or partially of rotor windings. The stator means can consist entirely or partially of permanent magnets.

Another preferred exemplary embodiment of the flywheel-driven setting device is characterized in that the inner rotors comprise rotor windings rotatable radially within stator windings of the stator means. A magnetic field is built up during operation of the internal rotor motor over the windings or coils formed of the windings. This enables a simple design of the electric motor as a double series-wound motor in particular.

Another preferred exemplary embodiment of the flywheel-driven setting device is characterized in that air guiding elements are provided on the stator means, on the inner rotors and/or on the flywheel, which during operation of the inner rotor motors serve to generate a cooling air flow along the windings. The air guiding elements, for example, are fan plates. The air guiding elements can significantly improve the cooling of the internal rotor motors.

Another preferred exemplary embodiment of the flywheel-driven setting device is characterized in that the stator means are arranged symmetrically to a central axis of the flywheel which is rotationally fixedly connected to the rotor shaft in the axial direction between the stator means. The central axis of the flywheel is perpendicular to its axis of rotation.

Another preferred exemplary embodiment of the flywheel-driven setting device is characterized in that a flywheel body is connected to a rotor shaft by forming at least one annular cavity. The annular cavity is represented, for example, by bars and/or spoke-like connections between the flywheel body and the rotor shaft. The annular cavity allows that a large part of the flywheel mass can be advantageously shifted to radially outer areas. This improves the efficiency of the flywheel. Furthermore, the weight of the flywheel can be reduced compared to a flywheel without an annular cavity. This, in turn, reduces the total weight of the flywheel-driven setting device.

Another preferred exemplary embodiment of the flywheel-driven setting device is characterized in that a flywheel body is connected to a rotor shaft over a drive plate. The drive plate, for example, has the shape of a circular annular disk. The flywheel body extends advantageously radially outside the stator means in opposite axial directions. This allows a relatively large flywheel mass to be represented in a simple manner.

According to another exemplary embodiment, the internal rotor motor of the flywheel-driven setting device is equipped with Hall sensors for detecting a flywheel position and/or flywheel speed. The information recorded by the Hall sensors can be used to electronically control individual windings depending on the internal rotor position in order to drive the internal rotor motors.

The invention possibly also relates to a method of operating a previously described flywheel-driven setting device.

The invention may also concern a flywheel, an internal rotor and/or a stator means for a setting device described above. These parts can be sold separately.

Further advantages, features, and details of the invention result from the following description, in which different embodiments are described in detail with reference to the drawings. They show:

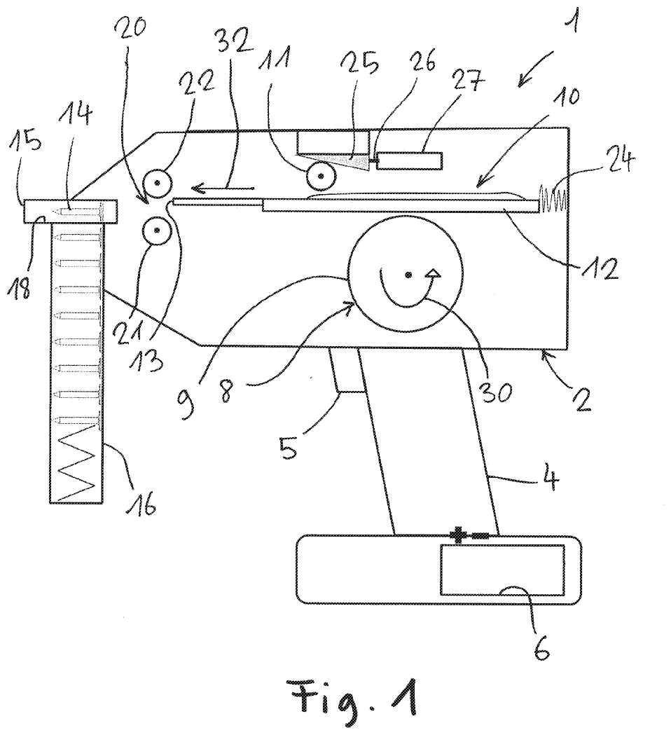

FIG. 1: a simplified representation of a flywheel-driven setting device with a Flywheel drive, which comprises an electric motor arrangement with two internal rotor motors;

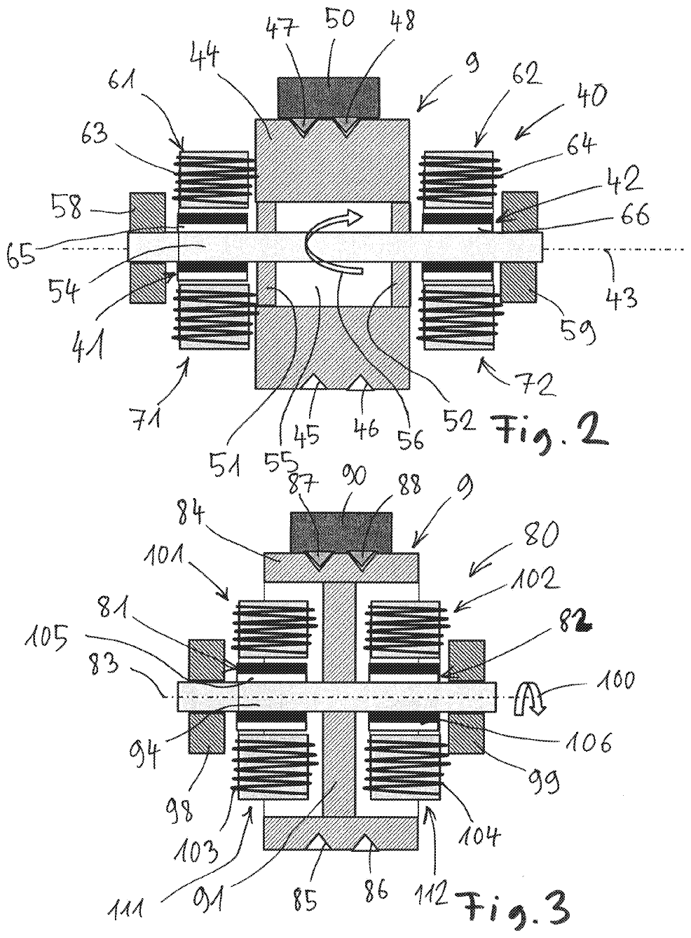

FIG. 2: a simplified representation of an exemplary embodiment of the flywheel drive with two internal rotor motors in longitudinal section; and

FIG. 3: a similar flywheel drive as in FIG. 2 with a more compact structure of the internal rotor motors.

### EXEMPLARY EMBODIMENTS

FIG. 1 presents a simplified flywheel-driven setting device 1 with a housing 2. The housing 2 has a handle 4 with a trigger 5. Therefore, setting device 1 is also referred to as a hand-held setting device or setting tool.

An accumulator 6 for storing electrical energy is integrated into a lower free end of the handle 4 of the setting device 1 in FIG. 1. The electrical energy of the accumulator 6 serves for driving an electric motor or an electric motor arrangement 8. The electric motor arrangement 8 advantageously comprises two internal rotor motors. With the two internal rotor motors, the flywheel 9 is advantageously directly driven. Using the two internal rotor motors, the flywheel 9 can be set in rotation quickly and with high torque.

The setting device 1 also comprises a driving element 10 with a setting piston 12, which is abbreviated to piston. The driving element 10 or the setting piston 12 is arranged between the flywheel 9 and a counter roller 11. The counter roller 11 can also be designed with the flywheel 9 and the driving element 10 in between, presented differently, as a helical gear coupling.

The setting piston 12 has a piston tip 13 at its left end as represented in FIG. 1, with which a fastening element 14 at the setting end 15 of setting device 1 can be driven into a (not represented) subsurface. The fastening elements 14 are, for example, bolts or nails which are preferably provided automatically by a magazine 16 at the setting end 15 of the setting device 1. As in FIG. 1 above the fastening element 14 arranged in the magazine 16 is guided in a bolt guide 18.

The setting piston 12 or the driving element 10 is guided in the setting device 1 using at least one piston guide 20 in the axial direction, i.e. to the left and to the right in FIG. 1, so that it can be moved back and forth. The piston guide 20 comprises two guide rollers 21, 22. For driving of the fastening element, the setting piston 12 with its piston tip 13 is moved with great acceleration through the piston guide 20 towards the fastening element 14. After a setting operation, the setting piston 12 is moved back to its initial position represented in FIG. 1 using a return spring 24.

The setting device 1 also comprises a wedge 25 which is movable by a plunger 26 through an electromagnet 27 in order to press the counter roller 11 in FIG. 1 downwards against the driving element 10. In this way, a way of coupling is represented which serves to frictionally connect the driving element 10 with the flywheel 9.

As soon as the frictional engagement is established, a rotational movement of the flywheel 9, indicated in FIG. 1 by an arrow 30, is transmitted to the driving element 10, so that it is moved in a setting direction, also indicated by an arrow 32 in FIG. 1, to the left towards the fastening element 14 in the bolt guide 18. As soon as the driving element 10 with the piston tip 13 hits the fastening element 14, it is driven into the subsurface at the setting end 15 of setting device 1.

FIGS. 2 and 3 represent two examples of flywheel drives 40; 80, each comprising an electric motor arrangement with two internal rotor motors 71, 72; 111, 112. By means of the flywheel drive 40; 80 with the two internal rotor motors 71, 72; 111, 112, a sufficiently large setting energy can be easily and quickly provided in a reduced installation space, which can be transferred via the flywheel 9 to a driving element 50; 90, which corresponds to the driving element 10 in FIG. 1.

The flywheel drive 40 represented in FIG. 2 comprises two internal rotors 41, 42, which can be rotated together about an axis of rotation 43. A flywheel 9 in FIG. 2 corresponds to a flywheel 9 in FIG. 1.

The flywheel 9 comprises a flywheel body 44. The flywheel body 44 has two annular grooves 45, 46 radially on the outside, in which wedge ribs 47, 48 engage. The wedge ribs 47, 48 are formed on an underside of the driving element 50. The wedge ribs 47, 48, which can be brought into engagement with the ring grooves 45, 46, simplify or improve the establishment of frictional engagement between the driving element 50 and the flywheel 9.

The flywheel body 44 is connected to a rotor shaft 54 via exemplarily represented bars 51, 52. Thus, an annular cavity 55 is represented in an advantageous way. The annular cavity 55 is limited radially outward by the flywheel body 44. Radially inward, the cavity 55 is limited by a rotor shaft 54. In axial directions, the ring cavity 55 is limited by the bars 51, 52.

The internal rotors 41, 42 of the internal rotor motors 71, 72 are also connected to the rotor shaft 54 in a rotationally fixed manner. An arrow 56 indicates a rotary movement of the rotor shaft 54 together with the flywheel body 44 and the inner rotors 41, 42. The rotor shaft 54 is rotatably mounted in an axial direction outwards by bearing means 58, 59, thus in FIG. 2 left and right. The bearing means 58, 59 are preferably fixed to the housing in the setting device.

The inner rotor 41 is rotatably arranged in a stator means 61 of the inner rotor motor 71. In the axial direction, the stator means 61 and the inner rotor 41 are arranged between the bearing means 58 and the flywheel 9.

The internal rotor 42 is rotatably arranged in a stator means 62 of the internal rotor motor 72. In the axial direction, the stator means 62 and the inner rotor 42 are arranged between the flywheel 9 and the bearing means 59.

The stator means 61, 62 are symmetrically arranged and designed together with the internal rotors 41, 42. A central axis of the flywheel 9, which is perpendicular to the axis of rotation 43, represents the axis of symmetry in the represented longitudinal section.

For the representation of the internal rotor motors 71, 72, the stator means 61, 62 are equipped with coil windings 63, 64, which are also referred to as stator windings. The internal rotors 41, 42 are equipped with permanent magnets 65, 66 which cooperate with each other and with the stator windings 63, 64.

The two inner rotors 41, 42 of the inner rotor motors 71, 72 are connected to each other and to the flywheel 9 via the common rotor shaft 54. The common rotor shaft 54 is rotatably mounted in the housing of the setting device by the bearing means 58, 59. The stator means 61, 62 are fixed in the housing of the setting device and do not rotate.

When the stator windings 63, 64 of the stator means 61, 62 are controlled synchronously, the rotor shaft 54 is set in rotation due to a cooperation between the stator windings 63, 64 and the permanent magnets 65, 66. This rotational movement is transferred to the flywheel body 44 of flywheel 9 via the bars 51, 52.

By coupling the coupling means, the rotary movement of the flywheel 9 for the driving of a fastening element is transmitted to the driving element 50. Due to the enormous power consumption when accelerating the flywheel 9, the stator windings 63, 64 become very hot. However, the waste heat occurring during the acceleration of the flywheel 9 can easily be transferred to the environment, for example via a fan on the rotor shaft 54.

The flywheel drive 80 represented in FIG. 3 with the two internal rotor motors 111, 112 comprises two internal rotors 81, 82 which can be rotated about an axis of rotation 83. A flywheel 9 which corresponds to the flywheel 9 in FIG. 1 comprises a flywheel body 84 which has two annular grooves 85, 86 radially outward. The annular grooves 85, 86 engage wedge ribs 87, 88 which are provided on an underside of a driving element 90. The driving element 90 corresponds to the driving element 50 in FIG. 2.

In contrast to the flywheel body 44 represented in FIG. 2, the flywheel body 84 of the flywheel 9 is non-rotatably connected to a rotor shaft 94 by a drive plate 91. The rotor shaft 94 is rotatably mounted with the internal rotors 81, 82 and the drive plate 91 with the flywheel body 84 of the flywheel 9 in FIG. 3 on the left and right using bearing means 98, 99 in the housing of the setting device. An arrow 100 indicates a rotation of the rotor shaft 94 with the internal rotors 81, 82 and the flywheel 9.

The inner rotors 81, 82 are arranged in the same way as the flywheel drive 40 represented in FIG. 2 so that they can rotate radially within stator means 101,102. The stator means 101, 102 are fixed in the housing of the setting device and are equipped with stator windings 103, 104.

The stator windings 103, 104 are in cooperation with permanent magnets 105, 106, which represent the inner rotors 81, 82. The flywheel drive represented in FIG. 3 with the two internal rotor motors 111, 112 has the advantage that it is more compact than the flywheel drive from FIG. 2.

1. A flywheel-driven setting device for driving fastening elements into a subsurface, having at least one flywheel which is driven directly by an electric motor, wherein the flywheel drive comprises two internal rotor motors.

2. The flywheel-driven setting device according to claim 1, wherein the flywheel drive comprises two internal rotors which are each arranged rotatably in a stator.

3. The flywheel-driven setting device according to claim 2, wherein the two internal rotors are non-rotatably connected to a rotor shaft which extends through the stators.

4. The flywheel driven setting device according to claim 2, wherein the two internal rotors comprise permanent magnets that are rotatable radially within the stators and that cooperate with stator windings.

5. The flywheel driven setting device according to claim 2, wherein the two internal rotors comprise rotor windings rotatable radially within permanent magnets of the stators.

6. The flywheel-driven setting device according to claim 2, wherein the two internal rotors comprise rotor windings rotatable radially within stator windings of the stators.

7. The flywheel-driven setting device according to claim 5, comprising air guiding elements provided on the stators, on the two internal rotors and/or on the flywheel, which serve during operation of the two internal rotor motors to generate a cooling air flow along the windings.

8. The flywheel-driven setting device according to claim 3, wherein the stators are arranged symmetrically relative to a central axis of the flywheel which is non-rotatably connected to the rotor shaft in an axial direction between the stators.

9. The flywheel-driven setting device according to claim 1, wherein the flywheel comprises a flywheel body that is connected to a rotor shaft while forming at least one annular cavity.

10. The flywheel-driven setting device according to claim 1, wherein the flywheel comprises a flywheel body that is connected to a rotor shaft via a driving plate.

11. The flywheel driven setting device according to claim 3, wherein the two internal rotors comprise permanent magnets that are rotatable radially within stators and that cooperate with stator windings.

12. The flywheel driven setting device according to claim 3, wherein the two internal rotors comprise rotor windings rotatable radially within permanent magnets of the stators.

13. The flywheel-driven setting device according to claim 3, wherein the two internal rotors comprise rotor windings rotatable radially within stator windings of the stators.

14. The flywheel-driven setting device according to claim 6, comprising air guiding elements provided on the stators, on the two internal rotors and/or on the flywheel, which serve during operation of the two internal rotor motors to generate a cooling air flow along the windings.

15. The flywheel-driven setting device according to claim 12, comprising air guiding elements provided on the stators, on the two internal rotors and/or on the flywheel, which serve during operation of the two internal rotor motors to generate a cooling air flow along the windings.

16. The flywheel-driven setting device according to claim 13, comprising air guiding elements provided on the stators, on the two internal rotors and/or on the flywheel, which serve during operation of the two internal rotor motors to generate a cooling air flow along the windings.

17. The flywheel-driven setting device according to claim 4, wherein the stators are arranged symmetrically relative to a central axis of the flywheel which is non-rotatably connected to the rotor shaft in an axial direction between the stators.

18. The flywheel-driven setting device according to claim 11, wherein the stators are arranged symmetrically relative to a central axis of the flywheel which is non-rotatably connected to the rotor shaft in an axial direction between the stators.

19. The flywheel-driven setting device according to claim 5, wherein the stators are arranged symmetrically relative to a central axis of the flywheel which is non-rotatably connected to the rotor shaft in an axial direction between the stators.

20. The flywheel-driven setting device according to claim 6, wherein the stators are arranged symmetrically relative to a central axis of the flywheel which is non-rotatably connected to the rotor shaft in an axial direction between the stators.
